(19) United States
(12) Patent Application Publication
(10) Pub. No.: US 2011/0233937 A1
(43) Pub. Date: Sep. 29, 2011

(54) AQUIFER-BASED HYDROELECTRIC GENERATION

(76) Inventor: William Riley, Captiva, FL (US)

(21) Appl. No.: 12/732,944

(22) Filed: Mar. 26, 2010

(51) Int. Cl. F03B 13/08; C02F 1/00

(52) U.S. Cl. 290/54; 405/127

(57) ABSTRACT

A system includes an aquifer and a source of fluid external to the aquifer. A fluid communication channel extends between the source of fluid and the aquifer. Fluid can flow from the source of fluid to the aquifer through the fluid communication channel. An engine-generator is arranged to convert energy of the flowing fluid into electrical energy. No pumps are provided to move fluid from the aquifer to the source of fluid.

### FIELD OF THE INVENTION

The present application relates to hydroelectric generation and, more particularly, to aquifer-based hydroelectric generation.

### BACKGROUND

Hydroelectric generation involves utilizing flowing fluid (e.g., water) to produce electrical energy (e.g., electricity. A large portion of the world's hydroelectric energy comes from dammed water driving a water turbine and generator.

Aquifers are naturally-occurring layers of permeable rock or unconsolidated materials that are capable of bearing fluid or do bear fluid.

### SUMMARY OF THE INVENTION

In one aspect, a system includes an aquifer and a source of fluid external to the aquifer. A fluid communication channel extends between the source of fluid and the aquifer. Fluid can flow from the source of fluid to the aquifer through the fluid communication channel. An engine-generator is arranged to convert energy of the flowing fluid into electrical energy. However, the system does not include any pumps to move fluid from the aquifer to the source of fluid.

In some implementations, the fluid that flows from the source of fluid to the aquifer does so substantially under the influence of gravity. In some implementations, the system includes a fluid injection pump to urge fluid through the fluid communication channel. In such implementations, the fluid that flows through the fluid communication channel does so at least partially under the influence of the fluid injection pump.

The engine-generator can be a turbine-generator arranged to convert energy of the flowing fluid into electrical energy.

In a typical embodiment, the aquifer is able to receive an influx of fluid from the source of fluid. In some embodiments, the aquifer is able to receive an influx of fluid from the source of fluid at least in part by virtue of being at least partially-depleted. In some embodiments, the aquifer is able to receive an influx of fluid from the source of fluid at least in part by virtue of the aquifer being unconfined.

The fluid that flows into the aquifer preferably should be of such quality that its introduction does not substantially compromise the aquifer's suitability for any use that the aquifer was suitable for prior to the introduction of fluid. In some implementations, the system includes one or more fluid treatment components arranged to treat fluid from the source of fluid prior to being introduced into the aquifer.

Certain embodiments include a valve to control flow of fluid through the fluid communication channel.

Certain implementations include one or more pumps arranged to move fluid from the aquifer to a location other than the aquifer and the body of fluid.

The engine-generator typically is a sufficient height above the aquifer that the fluid in the fluid communication channel does not back-up to such an extent as to compromise operation of the engine-generator.

The source of fluid can be any source of fluid external to the aquifer including, for example, a bog, a pond, a lake, a river, a stream, an aquifer, a fluid storage tank/container, an underground river or stream, the ocean and an other salt water body.

The aquifer (or aquifers) in a system generally includes a naturally-occurring underground layer of permeable rock or unconsolidated materials capable of bearing fluid.

In another aspect, a system includes an at least partially-depleted aquifer, which includes a naturally-occurring underground layer of water-bearing permeable rock or unconsolidated materials; and a source of fluid, such as a bog, a pond, a lake, a river, a stream, an aquifer, a fluid storage tank, an underground river, an underground stream, the ocean or other salt water body. The fluid that flows into the partially-depleted aquifer is of such quality that its introduction does not substantially compromise the aquifer's suitability for any use that the aquifer was suitable for prior to the introduction of fluid. A fluid communication channel extends between the body of fluid and the aquifer. Fluid can flow from the body of fluid to the aquifer through the fluid communication channel. A valve is arranged to control flow of fluid through the fluid communication channel. An engine-generator is arranged to convert energy of the flowing fluid into electrical energy. No pumps are provided to move fluid from the aquifer to the body of fluid.

In some implementations, the system includes a pump arranged to move fluid from the aquifer to a location other than the aquifer and the body of fluid.

In yet another aspect, a method includes identifying an aquifer that is able to receive fluid from an external source of fluid, enabling fluid to flow through a fluid communication channel from the source of fluid to the aquifer; and converting energy of the flowing fluid into electrical energy, without moving fluid from the aquifer to the source of fluid.

In some implementations, converting the energy of the flowing fluid into electrical energy includes directing the flowing fluid through a turbine-generator.

In certain embodiments, the method includes confirming or ensuring or treating the fluid that will flow into the aquifer so it is of such quality that its introduction will not substantially compromise the aquifer's suitability for any use that the aquifer was suitable for prior to the introduction of the fluid.

According to some implementations, the method includes manipulating a valve to control the flow of fluid through the fluid communication channel.

Some implementations include pumping fluid from the aquifer to a location outside the aquifer other than the body of fluid. The body of fluid can include, for example, a bog, a pond, a lake, a river, a stream, an aquifer, a fluid storage tank/container, an underground river or stream, the ocean or other salt water body.

The aquifer can include, for example, a naturally-occurring underground layer of permeable rock or unconsolidated materials capable of bearing fluid.

In yet another aspect, a system includes an unconfined aquifer comprising a naturally-occurring underground layer of water-bearing permeable rock or unconsolidated materials and a source of fluid (e.g., a bog, a pond, a lake, a river, a stream, an aquifer, a fluid storage tank, an underground river, an underground stream, the ocean or an other salt water body). A fluid communication channel extends between the body of fluid and the unconfined aquifer. Fluid can flow from the body of fluid to the unconfined aquifer through the fluid communication channel. A valve can control the flow of fluid through the fluid communication channel. An engine-generator can convert energy of the flowing fluid into electrical energy. The fluid that flows into the unconfined aquifer is of such quality that its introduction does not substantially compromise the unconfined aquifer's suitability for any use that the unconfined aquifer was suitable for prior to the introduction. No pump is arranged to move fluid from the unconfined aquifer to the body of fluid.

In some implementations, one or more of the following advantages are present.

For example, hydroelectric generating systems may be created at a relatively low cost. Accordingly, the resulting hydroelectric energy may be provided to end users at a more affordable rate. Moreover, electrical energy can be produced in a very clean, environmentally-friendly manner. The techniques disclosed herein can help reduce the amount of greenhouse gas produced in generating electrical energy.

Moreover, aquifers may be replenished or maintained in a highly cost-efficient manner. This may be important particularly in systems where the aquifer has become at least partially-depleted due, for example, to supplying drinking water, water for irrigation or some other purpose.

Other features and advantages will be apparent from the description and drawings, and from the claims.

### BRIEF DESCRIPTION OF THE DRAWINGS

FIG. 1 is a schematic diagram of an aquifer-based hydroelectric generation system.

FIG. 2 is a schematic diagram of an aquifer-based hydroelectric generation system with wells coupled to the aquifer.

FIG. 3 is a schematic diagram of an aquifer-based hydroelectric generation system with an unconfined aquifer.

FIG. 4 is a schematic diagram of an aquifer-based hydroelectric generation system with an injection pump.

FIG. 5 is a schematic diagram of an aquifer-based hydroelectric generation system with a fluid treatment facility.

FIG. 6 is a schematic diagram of an aquifer-based hydroelectric generation system with a surface-based a storage tank.

### DETAILED DESCRIPTION

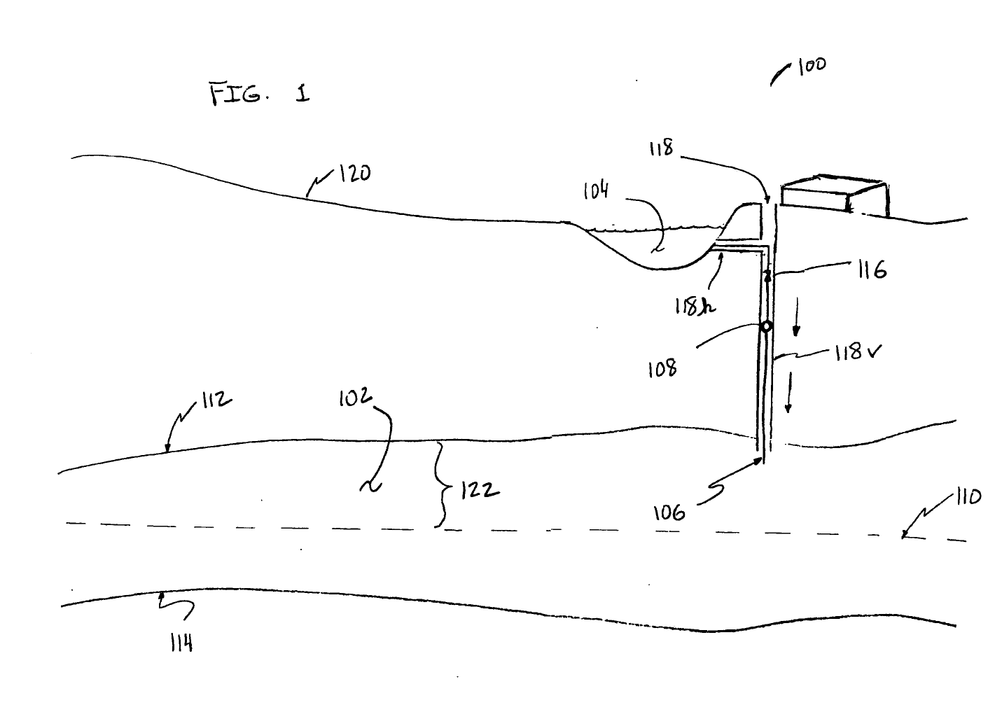

FIG. 1 is a schematic diagram of a system 100 that includes an aquifer 102 and an external source of fluid 104, which, in the illustrated example, is a lake at a higher elevation than the aquifer 102. A fluid communication channel 106 extends between the lake 104 and the aquifer 102. An engine-generator (e.g., a water turbine-generator 108) is arranged to convert the kinetic energy of fluid flowing through the fluid communication channel 106 from the lake 104 to the aquifer 102 into electrical energy.

In the illustrated system 100, the aquifer 102 is able to receive fluid from the lake 104. There are a variety of ways that an aquifer can have the ability to receive fluid from an external source, such as the lake 104. For example, the aquifer could be partially or completely depleted and, therefore, have a substantially fluid-free space inside the aquifer to store additional fluid. Aquifers can become depleted, for example, by being pumped or by virtue of fluid evaporating out of the aquifer. The pumping can be, but need not be, ongoing.

There are other ways that an aquifer can have the ability to receive fluid from an external source, such as the lake 104. For example, an unconfined aquifer has one or more openings that allow fluid to flow out of the aquifer. In some instances, if fluid is flowing into one area of an unconfined aquifer from an external source, a similar amount of fluid may flow out of the opening in the aquifer. Thus, even if the unconfined aquifer is substantially full before any influx of fluid occurs, the aquifer may be able to receive additional fluid from the external source because this influx of fluid is offset by an approximately equal amount of fluid flowing out of the aquifer.

In the illustrated system 100, the aquifer 102 is partially depleted. The aquifer's static fluid level, which is represented by a dashed horizontal line 110 about midway between the aquifer's upper 112 and lower 114 boundaries, shows that the aquifer 102 is about half full. Therefore, approximately the upper half of the aquifer 102 is substantially free of fluid. The substantially fluid-free upper portion 122 of the aquifer can receive and store additional fluid that may flow into the aquifer 102 from the lake 104 via fluid communication channel 106.

A valve 116 is provided in the fluid communication channel 106 and is operable to control the flow of fluid through the fluid communication channel. During typical system operations, the valve 116 would likely be either in a fully open position allowing fluid to flow from the lake 104 to the aquifer 102 or a fully closed position preventing the fluid flow from the lake 104 to the aquifer 102.

When the valve 116 is open, the fluid flowing through the fluid communication channel 106 passes through the turbine-generator 108. The turbine-generator 108 converts the kinetic energy of the flowing fluid to electrical energy, which can be used for a variety of purposes. For example, the turbine-generator 108 can be coupled to a electrical power grid that includes one or more other sources of electrical energy. In such systems, the turbine-generator 108 can supplement these other electrical energy sources, as needed.

Typically, the demand on an electrical grid that is supplying energy to a residential, commercial or industrial area will vary over time. If the turbine-generator 108 is intended to operate as a supplemental energy source for an electrical power grid supplying a varying demand, then the valve 116 may be throttled, either manually or automatically, in response to the varying demand. Such a system 100 can include a demand sensor to sense the demand on the grid and a controller to throttle the valve 116 in response to the sensed demand. The valve 116 can automatically open, thereby causing the turbine-generator to operate, when the sensed demand exceeds a first value, and automatically close, thereby causing the turbine-generator to stop operating, when the sensed demand drops below a second value. The first and second values can be the same or different.

In the illustrated system 100, fluid flows in only one direction through the fluid communication channel 106 (i.e., downward) from the lake 104 to the aquifer 102. The system 100 does not include a pump (or any other means) to move fluid from the aquifer 102 back up to the lake 104. Therefore, allowing the fluid to flow through the fluid communication channel 106 not only causes the turbine-generator to generate electricity, but also advantageously replenishes the aquifer's fluid supply.

Aquifer's can have varying degrees of permeability. In some implementations, the aquifer's permeability can be low enough that a back-up of fluid in the fluid communication channel 106 may occur as fluid is introduced into the aquifer. The turbine-generator 108, therefore, is generally located sufficiently high above the aquifer 102 that the flow of fluid through the fluid communication channel does not result in a back-up that might compromise operation of the turbine-generator 108.

In the illustrated system 100, the fluid communication channel 106, the valve 116 and the turbine-generator 108 are each located at least partially within borehole 118. The borehole 118 has a vertical portion 118v that extends from the earth's surface 120 downward into the aquifer 102 and a horizontal portion 118h that extends from the vertical portion 118v to the lake 104. The bottom end of the vertical portion 118h, which extends into the aquifer 102 is open, whereas the upper end of the vertical portion, at the earth's surface 120 can be, but need not be open. In a typical implementation, the lake-end of the borehole's horizontal portion 118h is sealed around the end of the fluid communication channel 106, whereas the opposite end is open to the vertical portion 116.

A variety of borehole 118, fluid communication channel 106 and component arrangements are possible and will be understood by one of ordinary skill.

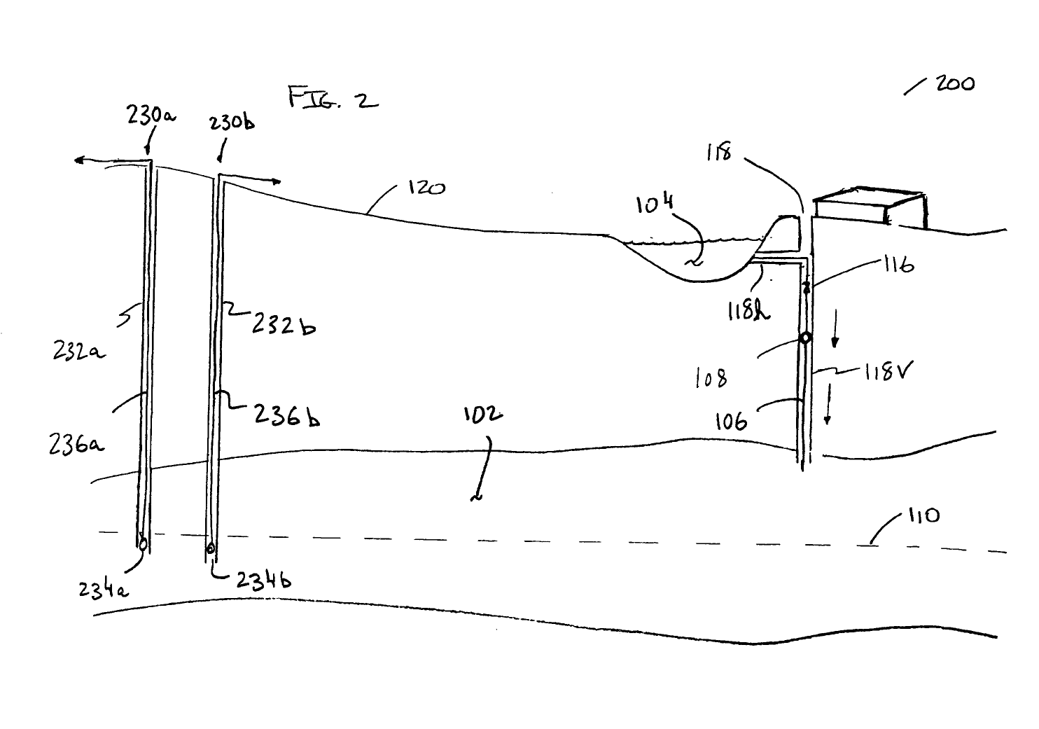

FIG. 2 is a schematic diagram of a system 200 that is similar to the system 100 of FIG. 1 except that system 200 also has wells 230a, 230b, each of which can draw fluid from the aquifer 102.

Each well 230a, 230b includes a borehole 232a, 232b, a pump 234a, 234b inside the borehole, and a fluid communication channel 236a, 236b extending through the borehole. The pumps 234a, 234b are below the aquifer's static fluid level 110. Each pump is operable to move fluid up from the aquifer 102 through its associated fluid communication channel 230a, 230b to a location outside the aquifer above the earth's surface 120.

The fluid that is pumped out of the aquifer 102 by pumps 234a, 234b can be used for a variety of purposes including, for example, drinking, irrigation, recreation, power generation, cooling applications, aquaculture, and/or many industrial processes and commercial uses. The fluid that is pumped out of the aquifer 102 by pumps 234a, 234b is not, however, pumped to the lake 104.

In the illustrated implementation, the pumps 234a, 234b are electric submersible pumps. However, the pumps can be implemented in a number of ways, for example, as a vertical turbine pump, a hand pump, a mechanical pump (e.g. from a water-pumping windmill) or containers, such as buckets, that are raised mechanically or by hand.

The illustrated aquifer 102 is partially depleted (see static fluid level 110) by virtue of having had fluid pumped out of it by pumps 234a, 234b. Since the aquifer 102 is partially depleted, it, therefore, is capable of accommodating fluid influx from the lake 104. The pumps 204a, 204b may be, but need not be, currently active. If the pumps 204a, 204b are no longer active, but once were active, then the partial depletion of the aquifer 102 may be the result of prior pumping by the pumps 234a, 234b.

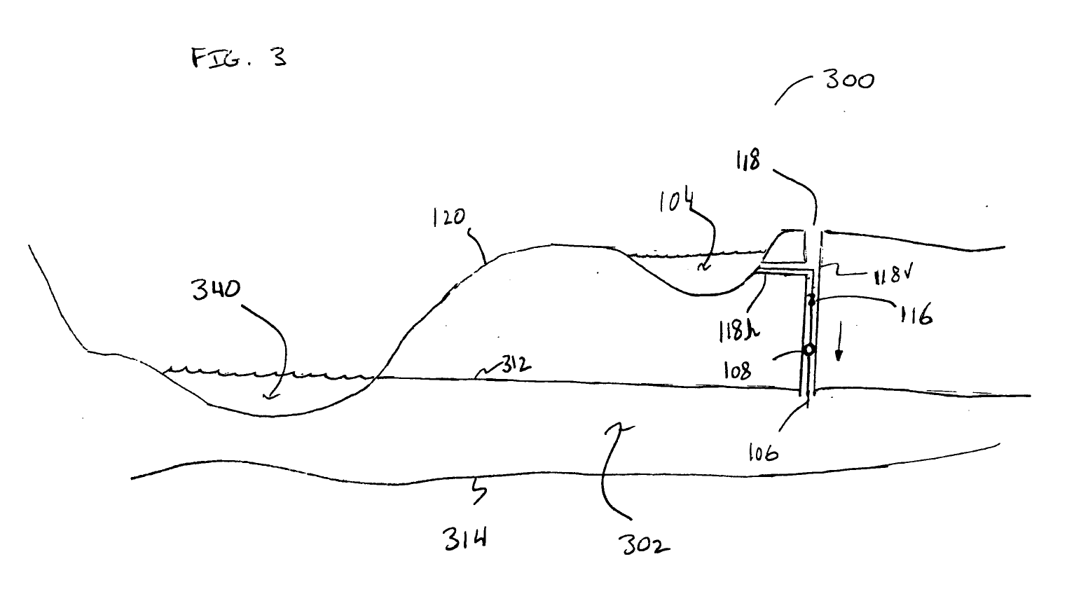

FIG. 3 is a schematic diagram of a system 300 that is similar to the system 100 of FIG. 1 except that the aquifer 302, which is bounded by its upper 312 and lower 314 boundaries, in system 300 is unconfined.

An unconfined aquifer is an aquifer that is open at the earth's surface (e.g., into a stream), and whose water level is generally free to fluctuate up and down, depending on the aquifer's discharge or recharge rate. In general, there are no overlying “confining beds” of low permeability that physically isolate the groundwater system in an unconfined aquifer. In the illustrated implementation, the aquifer is open at stream 340.

Since the illustrated aquifer 302 is unconfined and its water level can fluctuate up and down with run-off flowing into stream 340, the aquifer 302 is able to receive fluid from lake 104. In response to the influx of fluid, the level of fluid in the aquifer could simply rise. Conversely, evaporation or fluid run-off, for example, could cause the aquifer's fluid level to drop off.

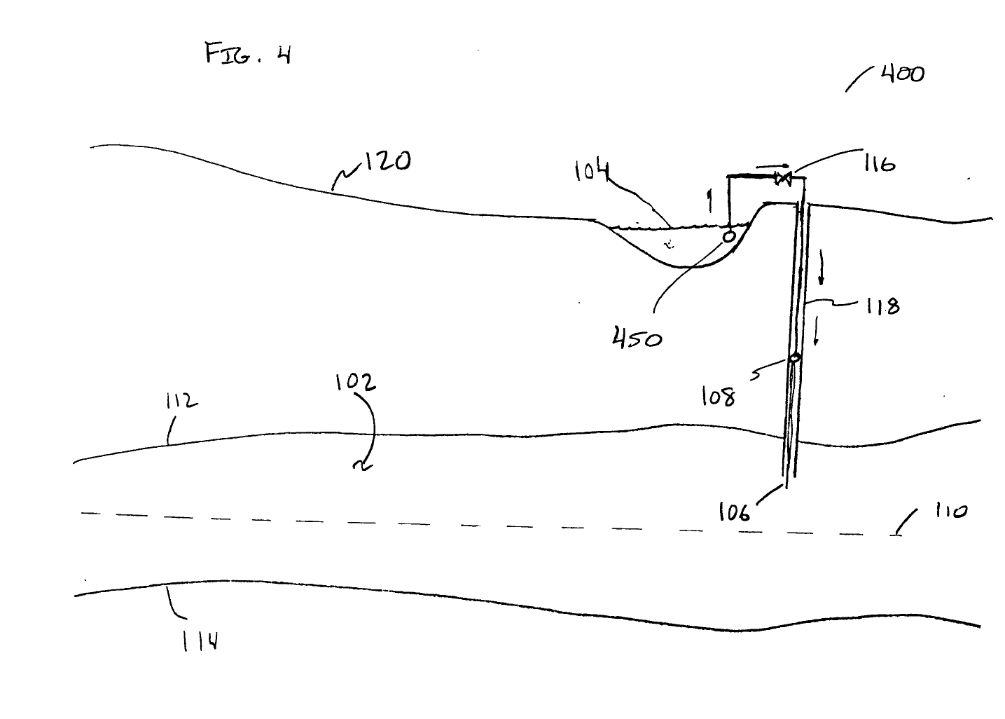

FIG. 4 is a schematic diagram of a system 400 that is similar to the system 100 of FIG. 1 except that the system 400 includes an injection pump 450 for urging fluid from the lake 104 down to the aquifer 102.

There are several reasons why an injection pump 450 may be desirable or necessary in some implementations. For example, in some implementations, an injection pump 450 is required because fluid needs to be pumped in an upward direction into the fluid communication channel 106. An example of this is shown in FIG. 4, where the fluid communication channel 106 extends in a substantially upward direction out of the lake 104. In the illustrated example, the pump 450 helps overcome the force of gravity.

In other implementations, even if the fluid communication channel is not configured in such a way that would require a pump, a pump, nevertheless, can be desirable. For example, if the aquifer that the fluid is being delivered to has relatively low permeability, then it may be necessary (or at least desirable) to include an injection pump 450 to overcome the aquifer's natural resistance to flow.

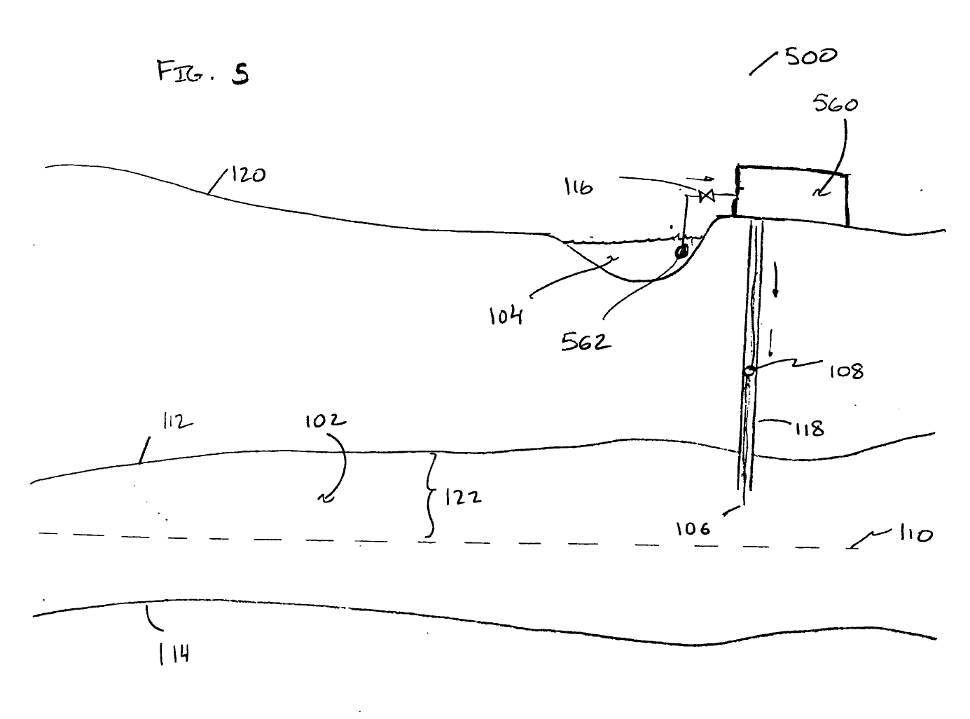

FIG. 5 is a schematic diagram of a system 500 that is similar to the system 400 of FIG. 4 except that system 500 includes a fluid treatment facility 560 for treating the fluid that is to be introduced into the aquifer 102.

In some implementations, it is a desirable to treat the fluid to ensure that it is suitable for introduction into the aquifer. In general, the fluid being introduced into the aquifer should be of a similar quality as the fluid that previously occupied the aquifer. Introduction of new fluid should not substantially compromise the aquifer's suitability for any use that it may previously have had. Nor should introduction of the new fluid substantially compromise the aquifer's suitability for any uses that the aquifer's fluid may have been suitable for prior to the introduction of the new fluid.

If, for example, the aquifer previously was used as a source of drinking water (or was suitable to be used as a source of drinking water), then the fluid being introduced into the aquifer should be suitable for drinking as well. Similarly, if the aquifer previously was used as a source of water for irrigation (or was suitable to be used as a source of water for irrigation), then the fluid being introduced into the aquifer also should be suitable for use as irrigation water. In a typical implementation, the illustrated treatment facility 560 would include provisions to help achieve these and other goals.

In the illustrated system 500, a pump 562 is arranged to pump fluid from the lake 104 into the treatment facility 560. In a typical implementation, the treatment facility 560 includes one or more systems or components to perform fluid treatment processes to affect physical, chemical and/or biological characteristics of the fluid. Some of these processes can include, for example, solid separation processes (e.g., settling or filtration); chemical treatment processes (e.g., disinfection or coagulation); biological treatment processes (e.g., processes involving the use of aerated lagoons, activated sludge or slow sand filters); chlorination; and aeration. Any combination of these and other processes can be performed by the treatment facility 560.

In some implementations, the electrical energy produced by the turbine-generator 108 is used to power the various processes being implemented at the treatment facility 560. In some implementations, the electrical energy produced by the turbine-generator 108 is directed to support operation of other systems or components including, for example, the injection pump, or one or more well pumps, control circuitry.

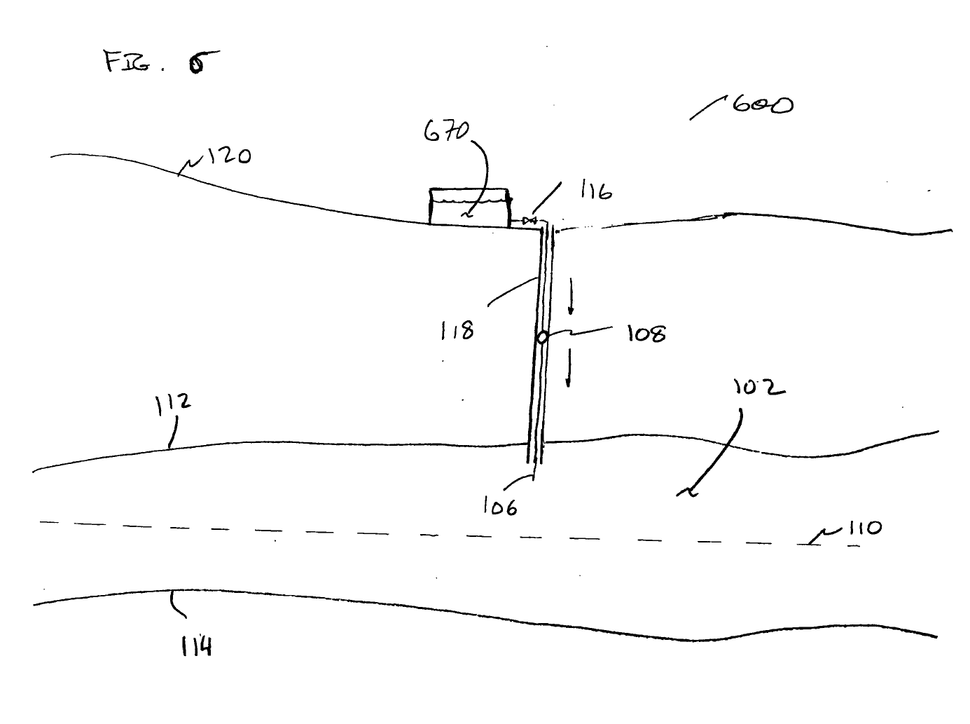

FIG. 6 is a schematic diagram of a system 600 that is similar to the system 100 of FIG. 1 except that the system 600 includes an above-ground fluid storage tank 670 as the external source of fluid. In a typical implementation utilizing an above-ground fluid storage tank 670, the tank itself is man-made.

A number of embodiments of the invention have been described. Nevertheless, it will be understood that various modifications may be made without departing from the spirit and scope of the invention.

For example, the engine-generator can be any component or system adapted to extract energy (e.g., kinetic energy) from the fluid flowing through the fluid communication channel. Additionally, the fluid communication channel can have a variety of possible configurations.

To help ensure that a sufficient amount of water continues to flow through the turbine, the portion of the fluid communication channel that extends from the turbine to the aquifer may include more than one conduit or pipe. The conduits or pipes can terminate at different locations in the aquifer so that, for example, if one of the locations becomes too saturated to continue absorbing fluid, some of the other locations may be able to continue absorbing fluid. Such an arrangement may help ensure that a sufficient amount of fluid continues to flow through the fluid communication channel to ensure that the turbine-generators continue to operate.

In general, the aquifer includes a naturally-occurring, at least partially underground layer of permeable rock or unconsolidated materials that is capable of bearing fluid (e.g., water) or that does bear fluid. The aquifer can be saturated or unsaturated, confined or unconfined, and can be essentially any type of aquifer.

The external source of fluid can be any source of fluid that is external to the aquifer. It can be, for example, a bog, a pond, a lake, a river, a stream, an aquifer, a fluid storage tank/container, an underground river or stream, another aquifer, the ocean or other salt water body.

Additionally, the bore holes that house some of the components disclosed herein can have different sizes and shapes. Some components including, for example, parts of the fluid communication channel(s) may be located above ground.

Some implementations include multiple engines connected in series in a single fluid communication channel. Some implementations include multiple injection pumps connected in series to the fluid communication channel. The valve or valves in the fluid communication channel may be configured in a variety of ways.

Moreover, the generator can be adapted to synchronize and connect to an electrical grid in a variety of ways. In some implementations, synchronization and connection is automated and controlled, for example, by an electronic controller.

The various implementations disclosed herein have different features from one another. However, the features from these implementations can be combined in a number of ways. For example, any of the disclosed systems can include a fluid treatment facility.

Additionally, the external source of fluid need not be at a higher elevation than the aquifer. Indeed, it need only be arranged so that fluid can flow from the external source of fluid to the aquifer 102. In some implementations, this can be possible in a substantially side-by-side arrangement. Indeed, this can be possible in some implementations where at least a portion of the external source of fluid is beneath the aquifer.

Accordingly, other implementations are within the scope of the claims.

What is claimed is:

1. A system comprising:
an aquifer;
a source of fluid external to the aquifer;
a fluid communication channel between the source of fluid and the aquifer, wherein fluid can flow from the source of fluid to the aquifer through the fluid communication channel; and
an engine-generator to convert energy of the flowing fluid into electrical energy;
wherein no pump is arranged to move fluid from the aquifer to the source of fluid.

2. The system of claim 1 wherein the fluid that flows from the source of fluid to the aquifer does so substantially under the influence of gravity.

3. The system of claim 1 further comprising:
a fluid injection pump to urge fluid through the fluid communication channel,
wherein the fluid that flows through the fluid communication channel does so at least partially under the influence of the fluid injection pump.

4. The system of claim 1 wherein the engine-generator is a turbine-generator arranged to convert energy of the flowing fluid into electrical energy.

5. The system of claim 1 wherein the aquifer is able to receive an influx of fluid from the source of fluid.

6. The system of claim 5 wherein the aquifer is able to receive an influx of fluid from the source of fluid at least in part by virtue of being at least partially-depleted.

7. The system of claim 5 wherein the aquifer is able to receive an influx of fluid from the source of fluid at least in part by virtue of the aquifer being unconfined.

8. The system of claim 1 wherein the fluid that flows into the aquifer is of such quality that its introduction does not substantially compromise the aquifer's suitability for any use that the aquifer was suitable for prior to the introduction.

9. The system of claim 8 further comprising:
one or more fluid treatment components arranged to treat fluid from the source of fluid prior to being introduced into the aquifer.

10. The system of claim 1 further comprising:
a valve to control flow of fluid through the fluid communication channel.

11. The system of claim 1 further comprising:
a pump arranged to move fluid from the aquifer to a location other than the aquifer and the body of fluid.

12. The system of claim 1 wherein the engine-generator is a sufficient height above the aquifer that the fluid in the fluid communication channel does not back-up to such an extent as to compromise operation of the engine-generator.

13. The system of claim 1 wherein the source of fluid is selected from the group consisting of: a bog, a pond, a lake, a river, a stream, an aquifer, a fluid storage tank/container, an underground river or stream, the ocean and an other salt water body.

14. The system of claim 1 wherein the aquifer comprises a naturally-occurring underground layer of permeable rock or unconsolidated materials capable of bearing fluid.

15. A system comprising:
an at least partially-depleted aquifer comprising a naturally-occurring underground layer of water-bearing permeable rock or unconsolidated materials;
a source of fluid selected from the group consisting of a bog, a pond, a lake, a river, a stream, an aquifer, a fluid storage tank, an underground river, an underground stream, the ocean and an other salt water body,
a fluid communication channel between the body of fluid and the at least partially-depleted aquifer, wherein fluid can flow from the body of fluid to the at least partially-depleted aquifer through the fluid communication channel;
a valve to control flow of fluid through the fluid communication channel; and
an engine-generator to convert energy of the flowing fluid into electrical energy,
wherein the fluid that flows into the at least partially-depleted aquifer is of such quality that its introduction does not substantially compromise the at least partially-depleted aquifer's suitability for any use that the at least partially-depleted aquifer was suitable for prior to the introduction;
wherein no pump is arranged to move fluid from the at least partially-depleted aquifer to the body of fluid.

16. The system of claim 15 further comprising:
a pump arranged to move fluid from the at least partially-depleted aquifer to a location other than the at least partially-depleted aquifer and the body of fluid.

17. A system comprising:
an unconfined aquifer comprising a naturally-occurring layer of water-bearing permeable rock or unconsolidated materials;
a source of fluid selected from the group consisting of a bog, a pond, a lake, a river, a stream, an aquifer, a fluid storage tank, an underground river, an underground stream, the ocean and an other salt water body,
a fluid communication channel between the body of fluid and the unconfined aquifer, wherein fluid can flow from the body of fluid to the unconfined aquifer through the fluid communication channel;
a valve to control flow of fluid through the fluid communication channel; and
an engine-generator to convert energy of the flowing fluid into electrical energy,
wherein the fluid that flows into the unconfined aquifer is of such quality that its introduction does not substantially compromise the unconfined aquifer's suitability for any use that the unconfined aquifer was suitable for prior to the introduction;
wherein no pump is arranged to move fluid from the at unconfined aquifer to the body of fluid.

18. A method of replenishing or maintaining an aquifer, the method comprising:
identifying an aquifer that is able to receive fluid from an external source of fluid;
enabling fluid to flow through a fluid communication channel from the source of fluid to the aquifer; and
converting energy of the flowing fluid into electrical energy,
the method being performed without moving fluid from the aquifer to the source of fluid.

19. The method of claim 18 wherein converting the energy of the flowing fluid into electrical energy comprises:
directing the flowing fluid through a turbine-generator.

20. The method of claim 18 further comprising:
confirming that the fluid that will flow into the aquifer is of such quality that its introduction will not substantially compromise the aquifer's suitability for any use that the aquifer was suitable for prior to the introduction.

21. The method of claim 18 further comprising:
manipulating a valve to control the flow of fluid through the fluid communication channel.

22. The method of claim 18 wherein the body of fluid is selected from the group consisting of: a bog, a pond, a lake, a river, a stream, an aquifer, a fluid storage tank/container, an underground river or stream, the ocean and other salt water body.

23. The method of claim 18 wherein the aquifer comprises a naturally-occurring underground layer of permeable rock or unconsolidated materials capable of bearing fluid.

24. A method comprising:
identifying an aquifer that is able to receive fluid from an external source of fluid;
enabling fluid to flow through a fluid communication channel from the source of fluid to the aquifer;
converting energy of the flowing fluid into electrical energy; and
pumping fluid from the aquifer to a location outside the aquifer other than the body of fluid,
the method being performed without moving fluid from the aquifer to the source of fluid.
